(19) United States
(12) Patent Application Publication
(10) Pub. No.: US 2007/0138820 A1
(43) Pub. Date: Jun. 21, 2007

(54) Universal Bag Well

(75) Inventors: Bradley J. Hanson, North Augusta, SC (US); Donald S. Hanson JR., Evans, GA (US); Anthony R. Rossello, Eagle Mountain, UT (US)

Correspondence Address: HARNESS, DICKEY & PIERCE, P.L.C., P.O. BOX 828, BLOOMFIELD HILLS, MI, 48303, US

(73) Assignee: TEXTRON INC., Providence, RI (US)

(21) Appl. No.: 11/622,694

(22) Filed: Jan. 12, 2007

Related U.S. Application Data
(63) Continuation-in-part of application No. 11/311,912, filed on Dec. 19, 2005.

(51) Int. Cl. B60R 11/06; B60R 9/00

(52) U.S. Cl. 296/37.14; 224/274

(57) ABSTRACT

A golf bag well arrangement on a golf car includes a receiving area defined on the golf car and adapted to accept at least one golf bag in a secure position. A first support surface is arranged on the receiving area and provides vertical support to the golf bag in the secure position. A second support surface is defined on the receiving area and provides lateral support to the golf bag in the secure position. The second support surface defines a first arcuate wall portion defined on the receiving area.

### CROSS-REFERENCE TO RELATED APPLICATIONS

This application is a continuation-in-part of U.S. patent application Ser. No. 11/311,912 filed on Dec. 19, 2005.

### TECHNICAL FIELD

The present invention relates to golf cars and more specifically to a golf bag well for accommodating a variety of golf bags.

### BACKGROUND

Golf cars provide transportation for golfers around a golf course. A golf car must also securely carry a golf bag in a location for convenient access throughout a round of golf. Typically, the rearward portion of the golf car defines a golf bag carrier area that supports the golf bag or bags in a centrally upright orientation. In one application, a support brace is provided for aligning with an upper portion of the golf bag and providing lateral support. Generally, a strap is affixed to the support brace for securing the golf bag to the golf car. A free end of the strap may be looped around the upper portion of the golf bag and pinched into a retained position with a swing arm pivotally mounted to the support brace. Often, two strap arrangements are available at the golf bag carrier area for accommodating two golf bags

The golf bag carrier area typically defines a bag well for accepting a base portion of the golf bags. Usually the bag well defines outer walls such that a golf bag, or bags, may nest in the bag well in a secure position. With the variety of golf bag configurations available today however, sometimes the dimensions of the bag well are not suitable for retaining the base of some golf bags securely. As a result, sometimes the golf bag may slide along its base portion in the bag well throughout a round of golf.

### SUMMARY

A golf bag well arrangement on a golf car includes a receiving area defined on the golf car and adapted to accept at least one golf bag in a secure position. A first support surface is arranged on the receiving area and provides vertical support to the golf bag in the secure position. A second support surface is defined on the receiving area and provides lateral support to the golf bag in the secure position. The second support surface defines a first arcuate wall portion defined on the receiving area.

According to other features, a second arcuate wall portion is defined on the receiving area. The second arcuate wall portion opposes the first arcuate wall portion and cooperates with the first arcuate wall portion to define a first pair of arcuate walls to retain a first rounded bottom golf bag therebetween in the secure position. A vertical divider wall is formed on the first support surface between the first and second pair of arcuate walls. The first support surface defines an opening adapted to drain fluid from the receiving area.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a golf car incorporating a universal bag well according to the present teachings;

FIG. 2 is a perspective view of the golf car of FIG. 1 shown with a first golf bag approaching the universal bag well;

FIG. 3 is a perspective view of the golf car of FIG. 1 shown with a second golf bag approaching the universal bag well;

FIG. 4 is a plan view of the universal bag well of FIG. 1;

FIG. 5 is a sectional view of the universal bag well shown with the first golf bag of FIG. 2 in an installed position;

FIG. 6 is a sectional view of the universal bag well shown with the second golf bag of FIG. 3 in an installed position;

FIG. 7 is an assembly view of an insert, being installed into a golf bag well of a golf car, and defining a golf bag receiving area according to various embodiments;

FIG. 8 is a perspective view of the insert of FIG. 7 shown in an uninstalled position;

FIG. 9 is a perspective view of a rear body portion of a golf car with the insert shown in an installed position;

FIG. 10 is a plan view of the insert of FIG. 8; and

FIG. 11 is a sectional view of the insert taken along line 11-11 of FIG. 10.

### DETAILED DESCRIPTION

The following description of the various embodiment(s) is merely exemplary in nature and is in no way intended to limit the invention, its application, or uses.

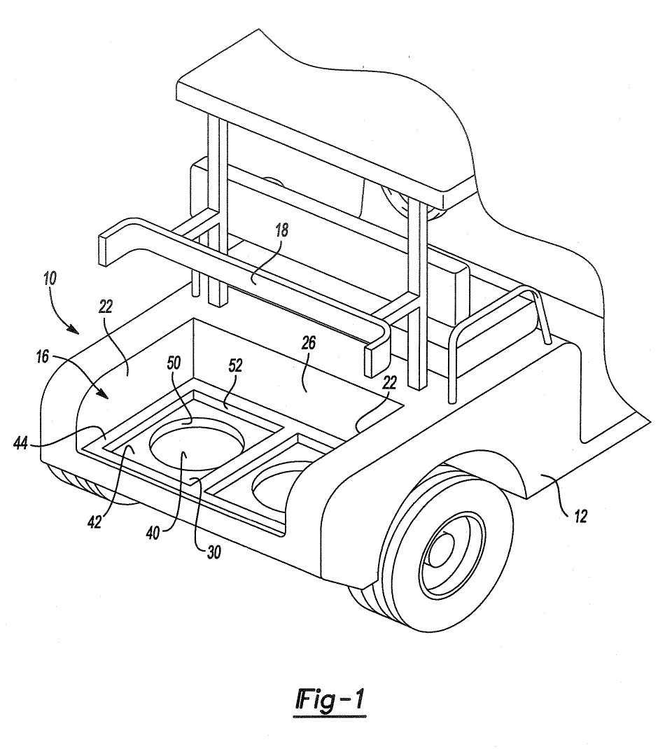

With initial reference to FIG. 1, a universal bag well according to the present teachings is shown and generally identified at reference 10. The bag well 10 is shown arranged on a golf car 12. The universal bag well 10 defines a lower boundary of a golf bag carrier area 16. An upper front boundary of the golf bag carrier area 16 is defined by a support brace 18. The support brace 18 is generally positioned on the golf car 12 to provide lateral support to the golf bag or bags while the golf bags are positioned in an upright manner on the universal bag well 10. The universal bag well 10 is generally defined between golf car wheel wells 22 and rearward of a well wall 26. The lower boundary of the universal bag well 10 includes a receiving area 30. As will be described in greater detail, the receiving area 30 of the universal bag well 10 is configured to accept golf bags having distinct geometries in a secure position.

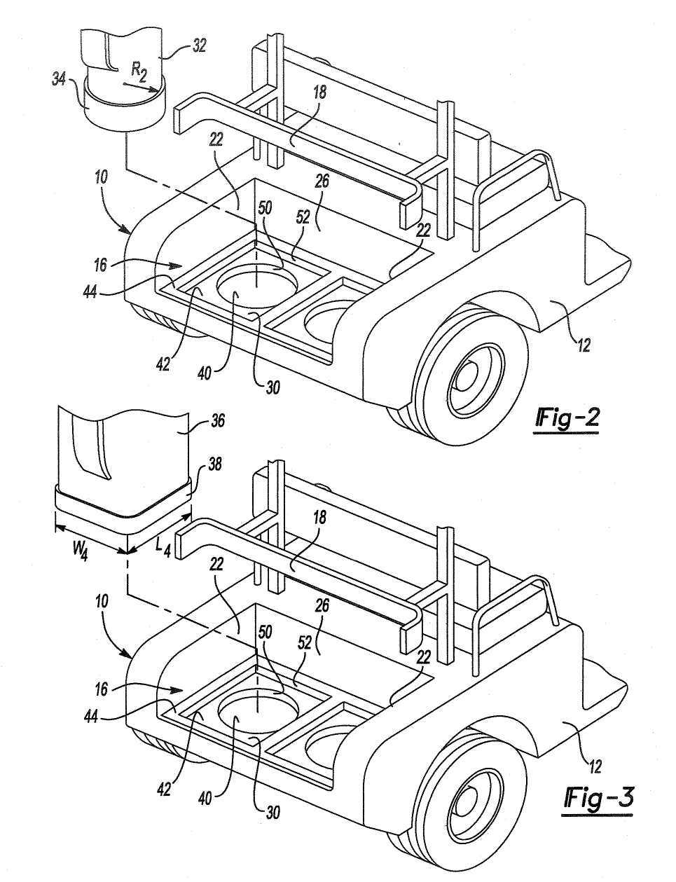

With continued reference to FIG. 1 and further reference to FIGS. 2 and 3, the universal bag well 10 will be described in greater detail. The receiving area 30 of the universal bag well 10 is adapted to accept a pair of golf bags concurrently in a side by side configuration. As illustrated in FIG. 2, a first exemplary golf bag 32, includes a generally cylindrical base portion 34. Alternatively, as illustrated in FIG. 3, a second exemplary golf bag 36 includes a generally rectangular base portion 38. For purposes of discussion, the receiving area 30 arranged on a drivers' side of the golf car 12 will be described in greater detail. It is appreciated however, that a receiving area 30 with the same configuration is provided on the passenger's side of the universal bag well 10.

The receiving area 30 includes a first, second, and third support surface 40, 42, and 44 respectively. A first retaining wall 50 extends between an outer boundary of the first support surface 40 and an inner boundary of the second support surface 42. The first retaining wall 50 is generally cylindrical in shape and has a depth D₁ (FIG. 5). The first retaining wall 50 is configured to accept a golf bag having a cylindrical base portion (such as golf bag 32 having cylindrical base portion 34). A second retaining wall 52 extends between an outer boundary of the second support surface 42 and an inner boundary of the third support surface 44. The second retaining wall 52 is generally rectangular in shape and has a depth D₂ (FIG. 5). The second retaining wall 52 is configured to accept a second golf bag having a rectangular base portion (such as golf bag 36 having rectangular base portion 38).

The first, second, and third support surfaces are parallel and offset from each other (FIG. 5). As a result, the first second and third support surfaces 40, 42, and 44 present a stepped configuration whereby a planar support surface 40, 42 and 44 and a complementary retaining wall 50 and 52 (or wheel well 22 and well wall 26) can be utilized to accept golf bags having various geometries. It is appreciated that while the first support surface 40 is shown bounded by a first retaining wall 50 having a cylindrical geometry and the second support surface 42 is shown bounded by a second retaining wall 52 having a rectangular geometry, the geometries may be reversed. Alternatively, the first and second retaining walls 50 and 52 may each present a cylindrical wall or each present a rectangular wall.

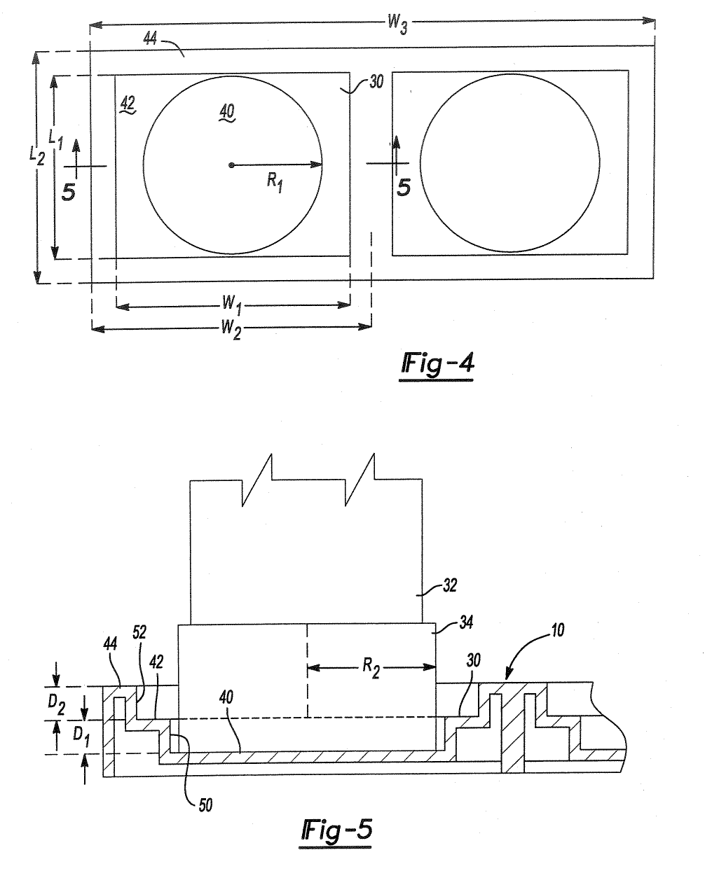

Turning now to FIG. 4, exemplary dimensions of the universal bag well 10 will be discussed. It is appreciated however that the dimensions described herein are merely exemplary and other dimensions may be defined on the receiving area 30 without departing from the present teachings. In general, the first support surface 40 may be adapted to accommodate a smaller footprint golf bag such as those around 229 mm in diameter. The second support surface 42 may be adapted to accommodate a larger footprint golf bag such as those around 267 mm in diameter. The first support surface 40 may include a radius R₁ of about 114 mm. The second support surface 42 may include a length L₁ of about 277 mm and a width W₁ of about 292 mm. The third support surface 44 includes a length L₂ of about 279 mm and a width W₂ of about 305 mm. The bag well 10 as a whole includes a width W₃ of about 610 mm.

With reference now to FIG. 5, the stepped configuration of the bag well 10 allows a base of a golf bag such as the golf bag 32 having the cylindrical base portion 34 to nest within the first retaining wall 50 and be supported by the first support surface 40. The exemplary golf bag 32 has a base defining a radius R₂. The radius R₂ is less than the radius R₁. A golf bag having a base defining a radius less than R₂ may also be accommodated by the first support surface 40.

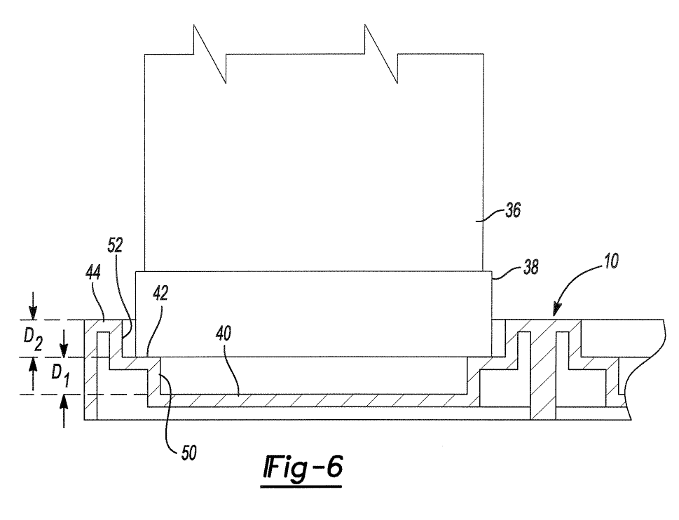

With reference now to FIG. 6, the golf bag 36 having the rectangular base portion 38 is shown accepted onto the second support surface 42. In an installed position (FIG. 6) the rectangular base 38 nests within the second retaining wall 52 and is supported by the second support surface 42. The exemplary golf bag 36 has a base having a length L₄ and a width W₄ (FIG. 3) A golf bag having a base defining a length and width less than L₁ and W₁, respectively, may also be accommodated by the second support surface 42.

While not specifically shown, a golf bag having a base portion defining a length and/or width greater than L₁ and W₁ and less than L₂ and W₂ may be supported by the third support surface 44. While such a golf bag will not specifically nest within a recess, it may be supported on a forward side by the well wall 26 and on a lateral side by one of the wheel wells 22.

The receiving area 30 of the bag well 10 may be made of a rigid material such as, but not limited to plastic. The receiving area 30 may be made as a standalone component and subsequently secured to the golf car 12 in the golf bag carrier area 16 such as by way of conventional fasteners or a flowable bonding compound. Alternatively, the receiving area 30 may comprise an integral component of the golf car 12. In one example, the receiving area 30 may be integrally formed with the golf car wheel wells 22 and/or the well wall 26.

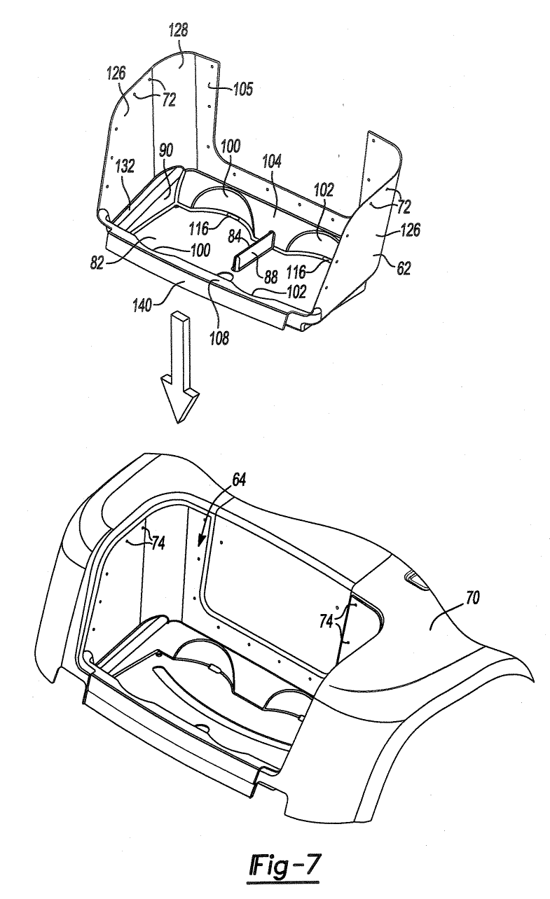

Turning now to FIGS. 7-11 a golf bag well arrangement 60 according to various embodiments will be described. The golf bag well arrangement 60 includes an insert 62 secured to a bag well 64 of a golf car 70. The insert 62 may be unitary and formed of rigid lightweight material such as polypropylene. In one non-limiting example, the insert 62 may be secured around its perimeter to the bag well 64 of the golf car 70 by fasteners (not shown) driven through complementary holes 72, 74 in the insert 62 and bag well 64, respectively. The insert 62, in an installed position defines a golf bag receiving area 80.

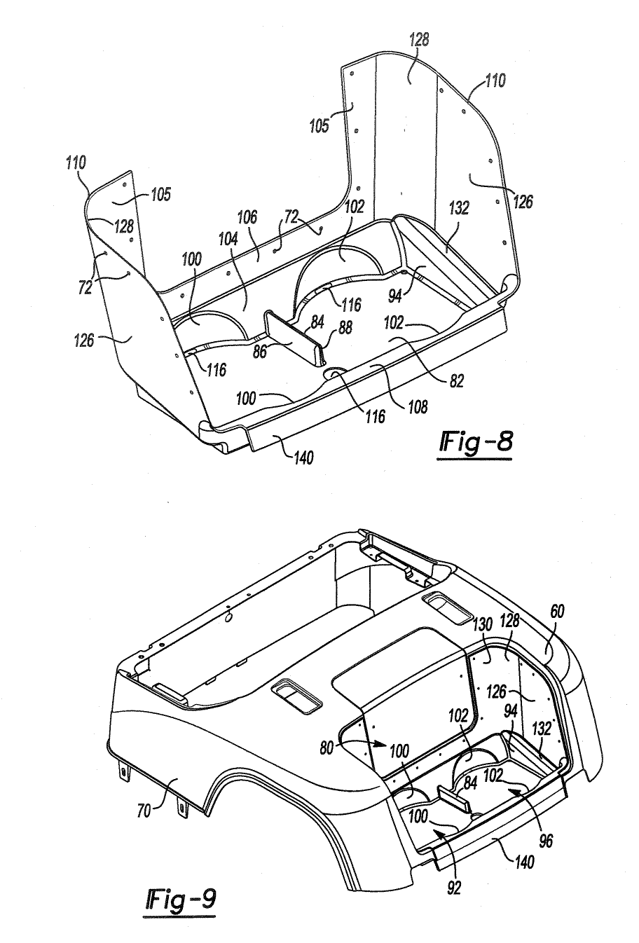

The golf bag receiving area 80 generally includes a first support surface 82 adapted to provide vertical support to a golf bag in a secure position. A vertical divider wall 84 extends upward from the first support surface 82 and is adapted to separate and provide lateral support to golf bags in the receiving area 80. The vertical divider wall 84 is generally planar and defines a driver side wall 86 (FIG. 8) and a passenger side wall 88 (FIG. 7), respectively. The driver side wall 86 cooperates with a first inner lateral sidewall 90 (FIG. 7) to define a pair of opposing lateral walls for a golf bag installed on a driver side 92 (FIG. 9). Similarly, the passenger side wall 88 cooperates with a second inner lateral sidewall 94 (FIG. 8) to define a pair of opposing lateral walls for a golf bag installed on a passenger side 96 (FIG. 9).

The receiving area 80 further defines two pair of opposing arcuate wall portions 100 and 102. Each pair of opposing arcuate wall portions 100 and 102 generally define a discontinuous radial wall adapted to bound a rounded base golf bag in an installed position. An arced wall 104 extends from the first support surface 82 to a rear wall 105 of the insert 62. A rearward wall 106 extends from the first support surface 82 to a horizontal step 108. The arcuate wall portions 100 and 102 on a forward end of the receiving area 80 are formed along the arced wall 104. The arcuate wall portions 100 and 102 on a rearward end of the receiving area are formed along the rearward wall 106. An outermost edge 110 of the receiving area 80 is chamfered to discourage golf bags from catching during installation.

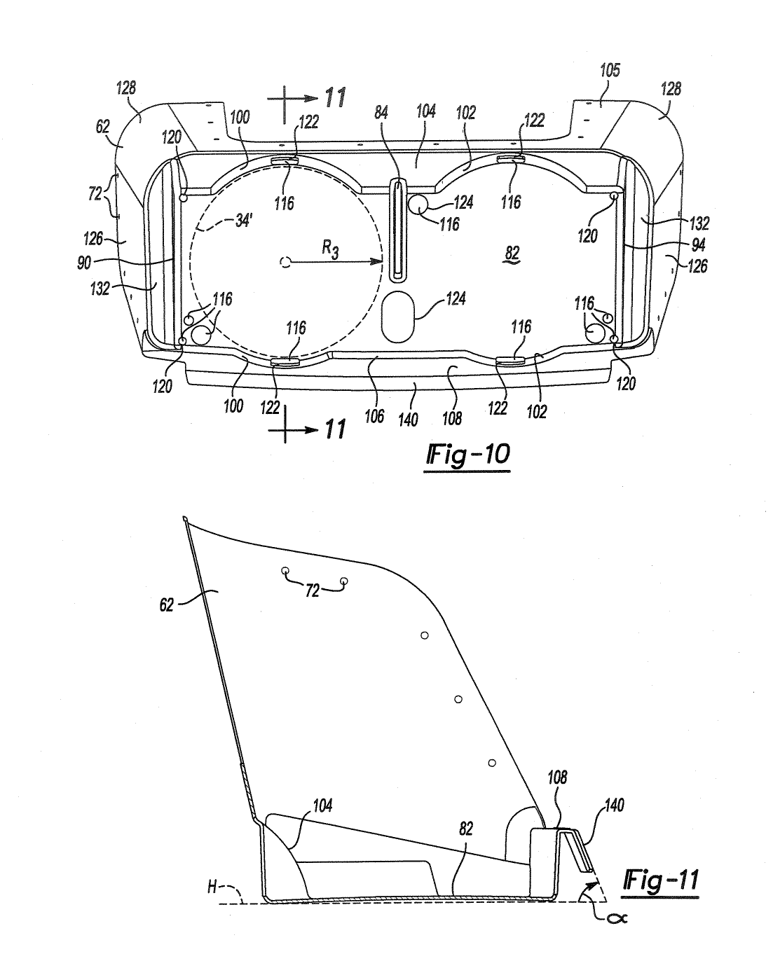

With specific reference now to FIG. 10, the receiving area 80 defines a plurality of openings 116 formed thereon adapted to drain fluid such as rain out of the receiving area 80. The first support surface 82 generally slopes downward in all directions toward a perimeter. A first series of openings 120 are arranged around corners of the receiving area 80. A second series of openings 122 are arranged at the intersection between the first support surface 82 and the first and second pair of opposing arcuate wall portions 100 and 102. Other openings 124 are arranged proximate the vertical divider wall 84.

With continued reference to FIGS. 9 and 10, the receiving area 80 defines a pair of outer lateral sidewalls 126, a pair of curved walls 128 and the rear wall 106. The outer lateral sidewalls 126 are stepped out from the inner lateral sidewalls 90, 94. A stepped wall 132 connects the inner and outer lateral sidewalls 90, 94, and 126, respectively. The stepped configuration allows a golfer simplified access to golf bag pockets. In this regard, the inner lateral sidewalls 90, 94 bound a base of a golf bag 34′ in an installed position, allowing a user to gain access to peripheral pockets of the golf bag 34′ through an entry space created between the inner and outer lateral sidewalls 90, 94, and 126, respectively. The arcuate wall portions 100 and 102 are configured to securely accept large rounded base golf bags. In one example, the golf bag 34′ may define a radius R3 of about 275 mm. In this way, the arcuate wall portions 100 and 102 may define a radius slightly greater than R3.

The arcuate wall portions 100 and 102 provide radial support around installed golf bags thereby resisting potential lateral sliding of the golf bags along the first support surface 82. It is important to note that the receiving area 80 is not limited to accepting rounded base golf bags. Other golf bags such as those having a rectangular base may be accepted by the receiving area 80. In one example, a first pair of opposite sides on a rectangular golf bag installed on the driver's side 92 may be bound by the vertical divider wall 84 and lateral wall 90. The second pair of opposite sides may be bound by the lowermost edge of arced wall 104 and the rearward wall 106.

With continued reference to FIG. 10 and further reference to FIG. 11, an outboard wall 140 extends at an angle α relative to horizontal line H. The outboard wall 140 is adapted to provide structural support to the insert 62 and receiving area 80 as a whole such as in the event of a rear impact.

Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the drawings, the specification and the following claims.

What is claimed is:

1. A golf bag well arrangement on a golf car comprising:
a receiving area defined on the golf car and adapted to accept at least one golf bag in a secure position;
a first support surface arranged on said receiving area and providing vertical support to said golf bag in said secure position;
a second support surface defined on said receiving area and providing lateral support to said golf bag in said secure position; and
wherein said second support surface defines a first arcuate wall portion defined on said receiving area.

2. The golf bag well arrangement of claim 1, further comprising a second arcuate wall portion defined on said receiving area.

3. The golf bag well arrangement of claim 2 wherein said second arcuate wall portion opposes said first arcuate wall portion and wherein said first and second arcuate wall portions cooperate to define a first pair of arcuate walls to retain a first rounded bottom golf bag therebetween in said secure position.

4. The golf bag well arrangement of claim 3 wherein said receiving area further includes a third and fourth arcuate wall portions that cooperate to define a second pair of arcuate walls to concurrently retain a second rounded bottom golf bag therebetween.

5. The golf bag well arrangement of claim 4 wherein a vertical divider wall is formed on said first support surface between said first and second pair of arcuate walls.

6. The golf bag well arrangement of claim 4 wherein said first support surface defines an opening adapted to drain fluid from the receiving area.

7. The golf bag well arrangement of claim 6 wherein said opening is defined at an intersection between said first support surface and said second support surface.

8. The golf bag well arrangement of claim 4, further comprising a pair of outer lateral sidewalls defining an outer lateral boundary of said receiving area and a pair of inner lateral sidewalls defining an outer lateral boundary of said first support surface, wherein said outer lateral sidewalls are stepped out from said inner lateral sidewalls.

9. A golf bag well arrangement on a golf car comprising:
a receiving area defined on the golf car and adapted to accept at least one golf bag in a secure position;
a first support surface arranged on said receiving area and providing vertical support to said golf bag in said secure position;
a first pair of opposing lateral surfaces defined on said receiving area;
a second pair of opposing lateral surfaces defined on said receiving area; and
wherein said first pair of opposing lateral surfaces are generally planar and wherein said second pair of opposing lateral surfaces are generally arcuate, said first and second pair of opposing lateral surfaces cooperating to form a boundary around a first golf bag in an installed position.

10. The golf bag well arrangement of claim 9 wherein said first support surface defines an opening adapted to drain fluid from said receiving area.

11. The golf bag well arrangement of claim 10 wherein said opening is defined at an intersection between said first support surface and one of the second pair of opposing lateral surfaces.

12. The golf bag well arrangement of claim 9, further comprising:
a third pair of opposing lateral surfaces defined on said receiving area;
a fourth pair of opposing lateral surfaces defined on said receiving area; and
wherein said third pair of opposing lateral surfaces are generally arcuate and wherein said fourth pair of opposing lateral surfaces are generally planar, said third and fourth pair of opposing lateral surfaces cooperating to form a boundary around a second golf bag in a secure position

13. The golf bag well arrangement of claim 9, further comprising a pair of outer lateral sidewalls defining an outer lateral boundary of said receiving area and a pair of inner lateral sidewalls defining an outer lateral boundary of said first support surface, wherein said outer lateral sidewalls are stepped out from said inner lateral sidewalls.

14. The golf bag well arrangement of claim 13, further comprising an outboard wall defining an angle relative to the first support surface.

15. A golf bag well arrangement on a golf car comprising:
a receiving area defined on the golf car and adapted to accept at least one golf bag in a secure position;
a first support surface arranged on said receiving area and providing vertical support to said golf bag in said secure position; and
a second support surface defined on said receiving area and providing lateral support to said golf bag in said secure position, said second support surface including a first discontinuous radial wall.

16. The golf bag well arrangement of claim 15, further comprising a second discontinuous radial wall portion defined on said receiving area.

17. The golf bag well arrangement of claim 15 wherein said first support surface defines an opening adapted to drain fluid from said receiving area.

18. The golf bag well arrangement of claim 17 wherein said opening is defined at an intersection between said first support surface and one of the second pair of opposing lateral surfaces.

19. The golf bag well arrangement of claim 15, further comprising a pair of outer lateral sidewalls defining an outer lateral boundary of said receiving area and a pair of inner lateral sidewalls defining an outer lateral boundary of said first support surface, wherein said outer lateral sidewalls are stepped out from said inner lateral sidewalls.

20. The golf bag well arrangement of claim 13, further comprising an outboard wall defining an angle relative to the first support surface.
